(19) United States
(12) Patent Application Publication
(10) Pub. No.: US 2006/0047860 A1
(43) Pub. Date: Mar. 2, 2006

(54) Flash memory device with a plurality of protocols and a method for controlling the flash memory device

(75) Inventor: Feng Hsi Lin, Shulin City (TW)

Correspondence Address: TROXELL LAW OFFICE PLLC;SUITE 1404, 5205 LEESBURG PIKE, FALLS CHURCH, VA, 22041, US

(73) Assignee: Incomm Technologies Co., Ltd.

(21) Appl. No.: 11/097,279

(22) Filed: Apr. 4, 2005

(30) Foreign Application Priority Data
Aug. 27, 2004 (TW) 093213598

(51) Int. Cl. G06F 13/10

(52) U.S. Cl. 710/11

(57) ABSTRACT

A flash memory device with a plurality of protocols comprises a body, a memory device, a terminal group, and a control unit. The control unit is connected to the memory device and the terminal group for driving and controlling data access in the memory device. The control unit is at least able to transfer data by a SD (Secure Digital) protocol and a MMC (MultiMedia Card) protocol. The control unit further comprises a detection circuit. The detection circuit can detect the protocol supported by an external device, and can switch the control unit to use the SD protocol or the MMC protocol to transfer data to the external device.

### BACKGROUND OF INVENTION

1. Field of the Invention

The present invention is related to a flash memory device capable of supporting multiple protocols, in particular to a portable memory device, such as a flash memory card, which can communicate using two different protocols, e.g. SD and MMC. This invention is also related to a flash memory device that can support a plurality of protocols which can use a mechanism of automatically detecting and switching the protocol for direct connect to more than one host, and related to the control method for the flash memory device.

2. Description of the Prior Art

Along with the rapid advancement of informaiton technology, demands for information grow explosively. The availability and prevalence of small portable memory devices in recent years, e.g. the flash memory-based USB flash disk (commonly referred to as “silicon disk drive” or “thumb drive”) and memory cards, e.g. CF (compact flash), MS (memory stick), SD Card (Secure Digital card), MMC (MultiMedia card), and xD, and micro hard disk with CF or USB interface, or the external USB or PCMCIA interfaced 2.5-inch hard disk, have more or less satisified our increasing longing for “information portability”.

Currently available portable memory devices ordinarily comprise a non-volatile memory array, a controller, and a transfer interface (I/O Interface). The memory array is used for storing data and must be capable of preserving the stored data without external power supply. Thus memory array typically consists of flash memory or a hard disk. The controller comprises circuits, interfaces and driving mechanism for driving and accessing the memory array. The driving mechanism may be provided as a hardware in the form of a command sequencer circuit for executing a series of micro-code programs, or in the form of a micro-controller/micro-processor circuit disposed in the controller of the portable memory device for executing a series of firmware programs. The transfer interface will determine the protocol by which the portable memory device can link and communicate with an external device.

Among memory cards of different specifications, Secure Digital card (called SD card below) and MultiMedia Card (called MMC card below) have the same profile specifications, except that SD card has an additional write protect button, whereas MMC card does not. Otherwise, the only difference between a SD card and a MMC card is the protocol. Currently SD/MMC combo card reader that can support both SD and MMC protocols to access the data in SD card and MMC card is already available on the market. But so far none of flash memory devices (i.e. flash memory cards) on the market are found to support both SD and MMC dual protocols.

U.S. Pat. No. 6,676,420 and U.S. Pat. No. 6,567,273 disclosed a kind of single flash memory card with two different sets of connectors and transfer interfaces set thereon for supporting double interface. However, both U.S. Pat. No. 6,676,420 and U.S. Pat. No. 6,567,273 need to use two different sets of connectors to transfer data in different interfaces respectively, which are completely different technology from the present invention.

U.S. Pat. No. 6,385,677 and U.S. Pat. No. 6,658,516 disclosed a kind of single flash memory card with USB transfer interface set thereon in addition to the card's own interface to achieve the function of supporting double interface. However, the memory cards in those patents does not have USB connector, thereby requiring an external adapter for connecting and using USB interface, which apparently resorts to different technology from the present invention.

### SUMMARY OF INVENTION

The main object of the invention is to provide a flash memory device with a plurality of protocols that will provide at least two different protocol specifications in a control chip of a single flash memory device. In addition, the single flash memory device may be directly connected to external devices with different protocols via the same set of terminal groups (having the same interface) to transfer data.

Another object of the invention is to provide a flash memory device with a plurality of protocols that can accommodate both SD and MMC protocols in a single memory card simultaneously by taking advantage of the characteristics of CD card and MMC card having the same profile specifications, and allows direct connection of more external devices through automatic detection and switching of the protocols.

A further object of the invention is to provide a flash memory device with a plurality of protocols that can transfer the switch position of write protect button in the form of signal to the control unit embedded in the flash memory device by arranging an additional set of switch circuit on the write protect button of a SD card, and to control and determine which protocol to be used for data transfer to an external device based on said signal (the switch position of write protect button).

To achieve the abovementioned objects, the present invention provides a flash memory device with a plurality of protocols. The flash memory device comprises a body, a memory device, a terminal group furnished on one side of the body, and a control unit. The control unit is connected to the memory device and the terminal group for driving and controlling data access in the memory device. The control unit further comprises a common interface circuit and a detection circuit. The common interface circuit is connected to the terminal group and can transfer data with at least a first protocol and a second protocol. The detection circuit is connected to the common interface circuit and can detect the specification of protocol supported by an external device, and can switch the control unit to use one of the first and second protocols to communicate with the external device. Therefore, the present invention can achieve the purpose of providing a single flash memory device which has at least two different specifications of protocols set thereon and may be directly connected to external devices with different protocols via the same set of terminal group for data transfer.

In a preferred embodiment, the profile size of the body meets the specification of a Secure Digital card, and the first protocol and the second protocol are Secure Digital card (SD) protocol and MultiMedia card (MMC) protocol respectively.

In a preferred embodiment, the body is further provided with a write protect button and a switch circuit. The write protect button can be switched between a first position and a second position. The switch circuit is connected to the write protect button and the control unit, and can transfer the switch position of write protect button in the form of a signal to the control unit. When the write protect button is at the first position, the control unit can use one of the first protocol or the second protocol to make two-way data communication with an external device; when the write protect button is at the second position, the control unit can use the second protocol to make two-way data communication with the external device, but only can use the first protocol to make one-way read-only data transfer. Therefore, it can achieve the purpose of using the switch position of the write protect button to control which protocol to use.

### BRIEF DESCRIPTION OF THE DRAWINGS

FIG. 1 is an embodiment of the structural appearance of a flash memory device 10 with a plurality of protocols according to the invention.

FIG. 2 is a circuit block diagram of a flash memory device with a plurality of protocols according to the invention.

FIG. 3 is a flowchart of an embodiment of the control method for a flash memory device with a plurality protocols according to the invention.

FIG. 4 is a circuit block diagram of a flash memory device with a plurality of protocols in the second embodiment of flash memory device according to the invention.

FIG. 5 is a flowchart of the control method (the detection procedure) in the second embodiment of flash memory device having a plurality protocols according to the invention.

FIG. 6 is an appearance of a reduced MultiMedia card (RS MMC).

FIG. 7 is an appearance of a mini Secure Digital card (mini SD).

### DETAILED DESCRIPTION

The principle of the flash memory device 10 with a plurality of protocols according to the invention is utilizing the characteristics of SD card and MMC card having the same profile specifications, thereby allowing the setting of SD and MMC protocols in a single memory card simultaneously, and allowing direct connection to more external devices 90 using the mechanism of automatic detection and switching of protocols. In addition, the transfer rate of many current SD protocols is higher than that of the MMC protocol. Thus when detecting the protocol supported by the external device 90, the flash memory device 10 of the present invention first attempts to use the SD protocol to make transfer. Even though the external device 90 can support both SD and MMC protocols, the invention can still first use the SD protocol with higher transfer rate to make transfer. In case that a MMC protocol with newer specification which can provide higher transfer rate appears in the future, the invention also can use a detection process stored in the flash memory device 10 to redefine the protocol with high priority.

To further illustrate the features, objects and functions of the present invention, detailed descriptions will be provided with reference to the accompanying drawings:

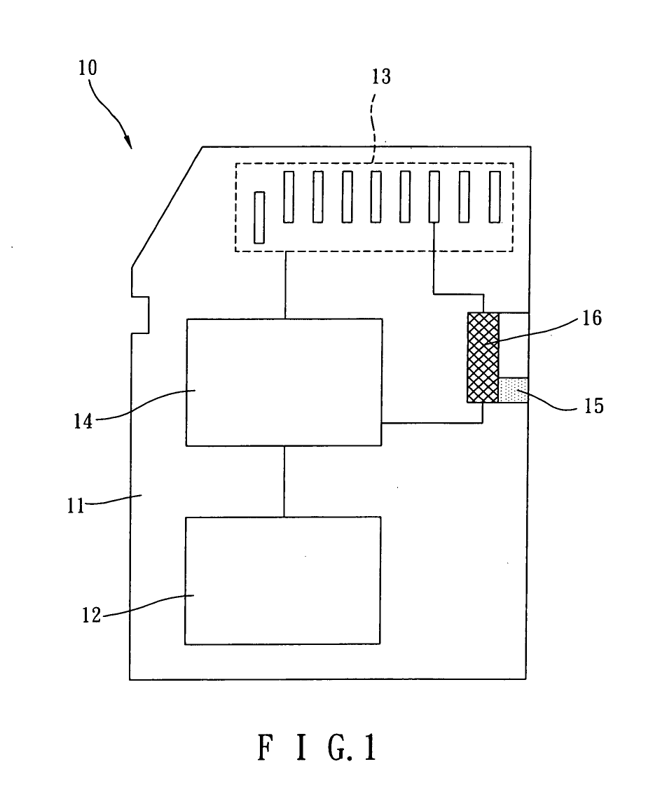

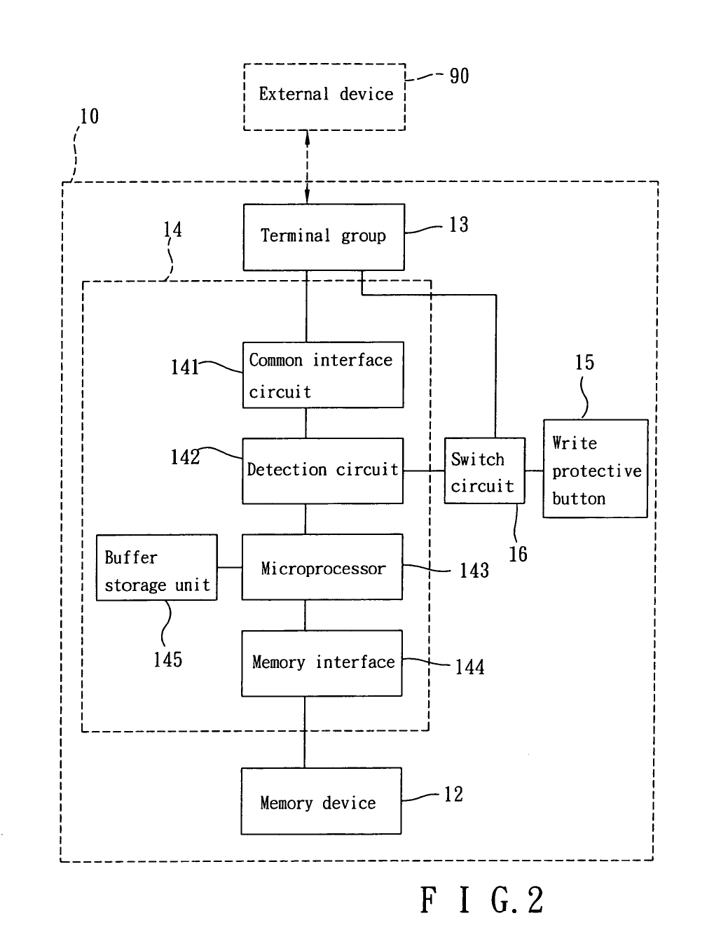

Referring to FIG. 1 and FIG. 2, a first preferred embodiment of a flash memory device 10 with a plurality of protocols according to the invention is shown. FIG. 1 is a structural appearance of a flash memory device 10 with a plurality of protocols according to the invention, wherein the embodiment of the flash memory device 10 with a plurality of protocols according to the invention is a flash memory card complying with the SD specification. FIG. 2 is a circuit block diagram of a flash memory device 10 with a plurality of protocols according to the invention.

As shown in FIG. 1 and FIG. 2, the first embodiment of the flash memory device 10 with a plurality of protocols according to the invention comprises a body 11, a memory device 12, a terminal group 13, a control unit 14, a write protect button 15, and a switch circuit 16.

The profile size of the body 11 meets the specification of a Secure Digital card (SD) and hence is compatible with the profile specification of a MultiMedia card (MMC). It is also possible to design the body 11 to make it meet the profile specification of a MultiMedia card (MMC) and that, of course, is still compatible with the profile specification of a Secure Digital card (SD).

The memory device 12 is mounted on the body 11 and consists of a plurality of rewritable non-volatile memory. In this preferred embodiment, the memory device 12 preferably comprises at lease a flash memory.

The terminal group 13 is furnished on the front side part of the body 11 and is exposed to the outside. The terminal group 13 may be electrically connected to an external device 90 (e.g. a card reader, a digital camera, a personal digital assistant, or a computer which has memory card slots) to transfer the control signal and digital data.

The control unit 14 is mounted on the body 11 and is connected to the memory device 12 and the terminal group 13. The control unit 14 is used to drive and control the data access within the memory device 12, and communicate data with the external device 90 via the terminal group 13. In this preferred embodiment, the control unit 14 may exist in the form of a control chip and further comprise a common interface circuit 141, a detection circuit 142, a microprocessor 143, a memory interface 144, and a buffer storage unit 145. The common interface circuit 141 is connected to the terminal group 13 and can transfer data with at least a first protocol and a second protocol. In this preferred embodiment, the common interface circuit 141 is a common interface circuit 141 with Secure Digital card/MultiMedia card (SD/MMC) protocol. And, the first protocol is the Secure Digital card (SD) protocol and the second protocol is the MultiMedia card (MMC) protocol. The detection circuit 142 is connected to the common interface circuit 141 and can detect the specification of protocol supported by an external device 90, and can switch the control unit 14 to use one of the first and second protocols (i.e. SD or MMC) to communicate data with the external device 90. The microprocessor 143 is connected between the detection circuit 142 and the memory device 12, to enable the control unit 14 to use the first and second protocols to transfer data from and/or into the terminal group 13. The memory interface 144 (Flash Interface) is connected between the microprocessor 143 and the memory device 12, to enable the control unit 14 to store data in the memory device 12 and read data from the memory device 12. The buffer storage unit 145 is connected to the microprocessor 143 for temporarily storing data.

The write protect button 15 is furnished on one side of the body 11, which meets the SD specification. The write protect button 15 can be switched between a first position (write protect off) and a second position (write protect on). The switch circuit 16 is connected between the write protect button 15, the control unit 14 and a VSS terminal of the terminal group 13. The switch circuit 16 can transfer the switch position of the write protect button 15 in the form of an electric signal to the control unit 14. The control unit 14 will switch the protocol used for making data communication with the external device 90 according to the electric signal (i.e. the switch position of the write protect button 15). For example, when the write protect button 15 is at the first position (write protect off), the control unit 14 can use the first protocol or the second protocol to make two-way data communication with the external device 90; when the write protect button 15 is at the second position (write protect on), the control unit 14 can use the second protocol to make two-way data communication with the external device 90, but can only use the first protocol to make one-way read-only data transfer.

Therefore, the invention allows a flash memory device to provide at least two different specifications of protocol, and to connect directly electrically to external devices with different protocols via the same set of terminal group to transfer data without requiring any additional adapter.

For a traditional and conventional SD card with single protocol, when the write protect button is switched to the second position (write protect on), the external device can only perform one-way data read-only function on the SD card with single protocol and is unable to write data into the SD card with single protocol. Therefore, the invention in particular makes use of this characteristics, such that when the flash memory device 10 is connected to an external device 90 which supports both SD/MMC protocols and when the user hopes to give priority to the MMC protocol to make two-way data transfer, the user can switch the write protect button to the second position (write protect on) and give priority to the MMC protocol for transferring data when the flash memory device 10 with a plurality of protocols detect that the external device 90 can support MMC protocol. Whereas, if the external device 90 only supports SD protocol, this will enable the one-way data read-only.

For the abovementioned control method for a plurality protocols, it can be executed by the design of a hardware circuit or by software control. In the invention, the preferred embodiment of the control method for a plurality protocols according to the invention is a detection procedure pre-stored in the memory device 12. The detection procedure can control the control unit 14 to use predefined steps for determining whether the first protocol or the second protocol should be used for transferring data.

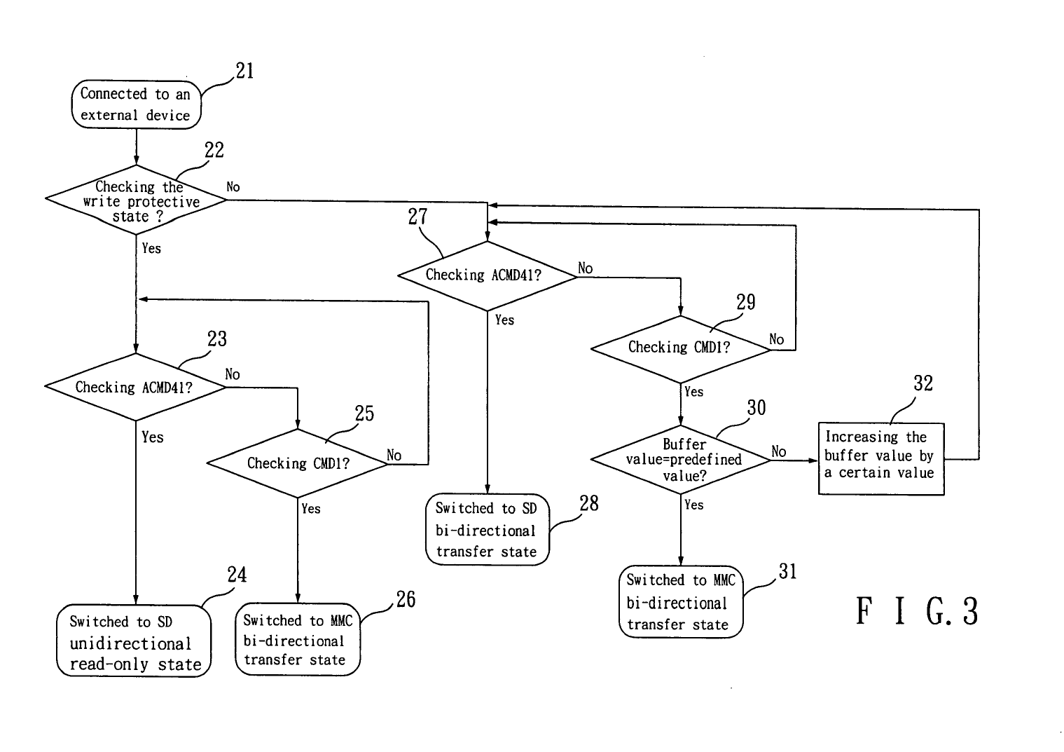

As shown in FIG. 3, a flowchart of a preferred embodiment of the control method, i.e. the detection procedure, for a plurality protocols according to the invention is shown. The control method for a plurality protocols comprises at least the following steps:

Step 21: connecting the flash memory device 10 to the external device 90; wherein, a buffer value stored in the flash memory device was set to zero when the flash memory device 10 is manufactured in the factory.

Step 22: checking if the switch position of the write protect button 15 is in the write protect on state; when the position of the write protect button 15 is at the first position (i.e. write protect off), the result is “No” and the process will proceed directly to step 27; when the position of the write protect button is at the second position (i.e. write protect on), the result is “Yes” and the process will proceed to step 23.

Step 23: receiving a control signal from an external device and checking if the control signal meets the first protocol signal (i.e. the control signal of the SD protocol, that is a ACMD41 signal), if “Yes”, the process will proceed to step 24; if “No”, the process will proceed to step 25.

Step 24: using the first protocol (i.e. the SD protocol) to make one-way data read-only transfer; and resetting the buffer value stored in the flash memory device 10 to zero.

Step 25: checking if the control signal meets the second protocol signal (i.e. the control signal of the MMC protocol, that is a CMD1 signal); if “Yes”, the process will proceed to step 26; if “No”, the process jumps back to step 23.

Step 26: using the second protocol (i.e. the MMC protocol) to make two-way data transfer; and resetting the buffer value stored in the flash memory device 10 to zero.

Step 27: receiving a control signal and detecting if the received control signal meets the first protocol signal (the ACMD41 signal of the SD protocol), if “Yes”, the process will proceed to step 28; otherwise, if “No”, the process will proceed to step 29.

Step 28: using the first protocol (i.e. the SD protocol) to make two-way data transfer; and resetting the buffer value stored in the flash memory device 10 to zero.

Step 29: detecting if the received control signal meets the second protocol signal (i.e. the CMD1 signal of the MMC protocol), if “Yes”, the process will proceed to step 30; if “No”, the process jumps back to step 27.

Step 30: checking if the buffer value meets a predefined value; if “Yes”, the process will proceed to step 31; if “No”, the process will proceed to step 32.

Step 31: using the second protocol (i.e. the MMC protocol) to make two-way data transfer; and resetting the buffer value stored in the flash memory device 10 to zero.

Step 32: storing the predefined value and overwriting the buffer value; if the buffer value equals to the predefined value, the process jumps back to step 27.

Alternatively in another preferred embodiment, the buffer value will be increased or decreased by a certain value and jumps back to step 27 in this step 32. At this time, the predefined value is preferably an integer multiple of the certain value.

The control method of the invention adopts those abovementioned steps as a preferred embodiment due to the higher data transfer rate of current common SD cards available on the market as compared to that of MMC card of version 4.0 or before. Therefore, when the flash memory device 10 with a plurality of protocols according to the invention is connected to an external device 90 which simultaneously supports both SD/MMC protocols, the user may desire the flash memory device 10 to give priority to the SD protocol with higher transfer rate to transfer data. However, the default value of currently available external devices (e.g. card readers) which simultaneously support SD/MMC protocols is set to give priority to check if a MMC card is connected. Therefore, the control method of the invention which is specially designed as a detection procedure consisting of those abovementioned steps can overcome the problem by ignoring the control signal CMD1 of the MMC protocol occurring the first time. That is, if the external device checks the SD protocol first, then the control method of the invention will directly use the SD protocol to make transfer; however, if the external device checks the MMC protocol first, then the control method of the invention may accept the MMC protocol only when the external device does not support the SD protocol and the check signal of the MMC protocol has been consecutively sent out at least twice. Thereby, the control method for a plurality of protocols that gives priority to the SD protocol can be achieved.

In another preferred embodiment, those abovementioned steps can be easily modified to, for example, increase (or decrease) the buffer value by increment, until it equals to the predefined value. Alternatively, the control method of the invention may accept the MMC protocol only when the external device has consecutively sent out the check signal of the MMC protocol at least three, four, or more times and no check signal of the SD protocol has been sent out. Because those skilled in the art appreciate the slight modifications to those steps and can easily make equivalent modifications after reading the invention, those modifications will not be elaborated here.

However, considering that new specifications of MMC protocol have been developed that provide higher transfer rate than the current SD protocol, and if the user desires to first use the faster MMC protocol, the invention can redefine the priority of protocol by modifying the content of the detection procedure pre-stored in the memory device 12. Alternatively, as described previously, the invention specially uses the specific design of a write protect button 15 and a switch circuit 16. After the write protect button 15 has been switched to “on” state, the flash memory device 10 with a plurality of protocols according to the invention will immediately enable the MMC protocol to make two-way data transfer once the external device 90 supporting SD/MMC protocols first checks if a MMC card is connected. That is, the invention can enable the flash memory device 10 with a plurality of protocols connected to an external device 90 which supports SD/MMC protocols to first use the MMC protocol by switching the write protect button 15 to “on” state. However, it will first attempt to adopt the SD protocol to transfer data when the write protect button 15 is in “off” state.

That is, regardless the flash memory device 10 with a plurality of protocols according to the invention is connected to a commercially available external device which only supports single SD protocol or single MMC protocol, the invention always can smoothly switch to the same protocol to transfer data. And when the flash memory device 10 with a plurality of protocols according to the invention is connected to an external device which supports both SD/MMC protocols, then the invention will first detect the state of the write protect button 15. When the write protect button 15 is in “on” state and the external device which supports SD/MMC protocols first checks the CMD1 signal of the MMC protocol, the flash memory device 10 according to the invention will immediately use the MMC protocol to transfer data, thereby achieving the function of first attempting to use the MMC protocol. When the write protect button 15 is in “off” state and the external device which supports SD/MMC protocols first checks the CMD1 signal of the MMC protocol, the flash memory device 10 according to the invention will still ignore the first transferred CMD1 signal. Hence, the external device which supports SD/MMC protocols will mistakenly construe that the flash memory device 10 according to the invention does not support the MMC protocol, and sends out a ACMD41 signal of the SD protocol to cause the flash memory device 10 to adopt the SD protocol for data transfer. Thus the function of first attempting to use the SD protocol for transferring data can be achieved.

In other embodiments described hereinafter, most elements or steps are similar to those of the abovementioned embodiment. Thus the same or similar elements or steps are directly given the same reference name and numeral and will not be described in detail.

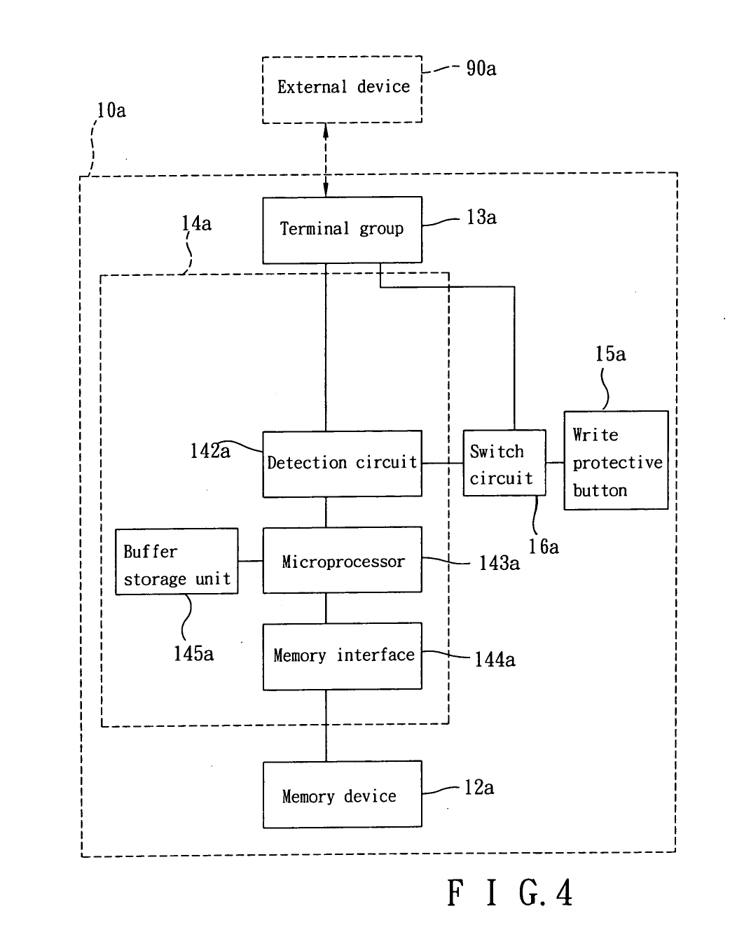

Referring to FIG. 4, the circuit block diagram of the flash memory device 10a with a plurality of protocols in the second embodiment of the invention is shown. The flash memory device 10a shown in FIG. 4 is almost the same as the embodiment shown in FIG. 2 and also comprises a body 11a, a memory device 12a, a terminal group 13a, a control unit 14a, a write protect button 15a, and a switch circuit 16a. The flash memory device 10a is also connectable to an external device 90a. Similarly, the control unit 14a also comprises a detection circuit 142a, a microprocessor 143a, a memory interface 144a, and a buffer storage unit 145a. The only difference is that, the control unit 14a of the flash memory device 10a shown in FIG. 4 is not furnished with a common interface circuit, but is directly coupling the terminal group 13a to appropriate contacts of the detection circuit 142a by conductive wires.

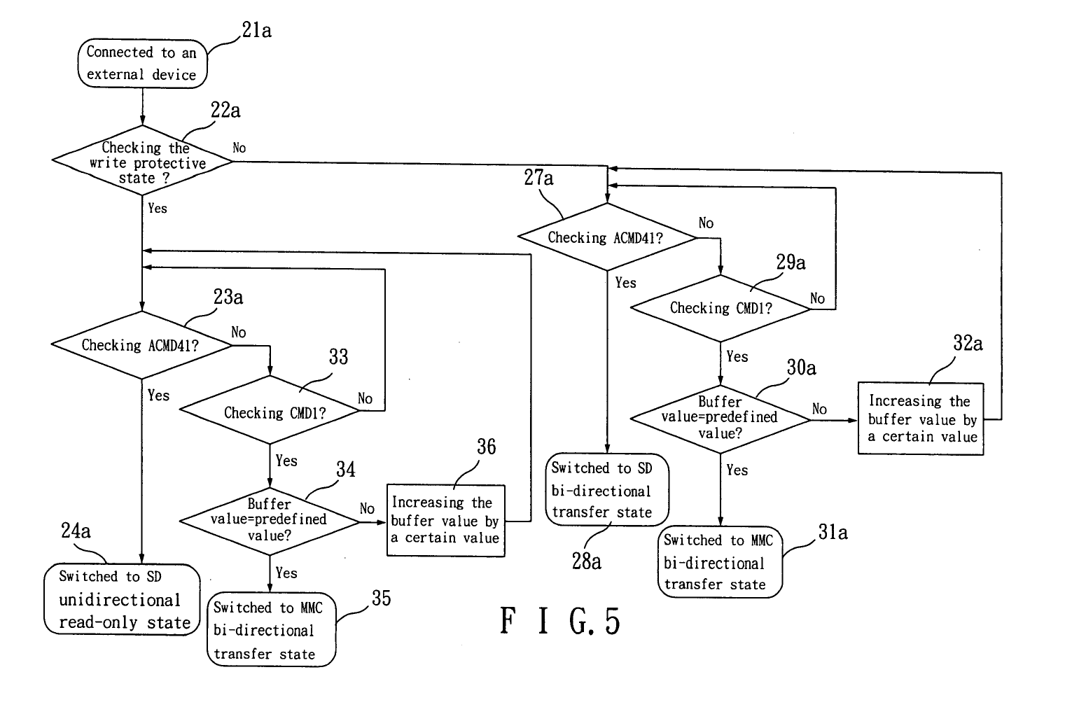

Referring to FIG. 5, a flowchart of a second preferred embodiment of the control method, i.e. the detection procedure for a plurality protocols according to the invention is shown. Steps 21a-24a and 27a-32a of the control method shown in FIG. 5 respectively correspond (or similar) to steps 21-24 and 27-32 of the flowchart shown in FIG. 3, which will not be described hereinafter. The difference of the control method shown in FIG. 5 lies in that when the result for checking the switch position of the write protect button in step 22a is “Yes” at the second position (i.e. write protect on) and the control signal does not (i.e., “No”) meet the first protocol signal (ACMD 41 signal) in step 23a, then the process will proceed to step 33. The flow process is described as follows.

Step 33: detecting if the received control signal meets the second protocol signal (the CMD1 signal of the MMC protocol); if “Yes”, the process will proceed to step 34; if “No”, the process jumps back to step 23a.

Step 34: checking if the buffer value meets a predefined value; if “Yes”, the process will proceed to step 35; if “No”, the process will proceed to step 36.

Step 35: using the second protocol (i.e. the MMC protocol) to make two-way data transfer; and resetting the buffer value stored in the flash memory device 10 to zero.

Step 36: increasing the predefined value by a certain value and jumping back to step 23a, wherein the predefined value is an integer (2, 3, or 4 etc.) multiple of the certain value.

With the detection procedure, when the write protect button is “Yes” at the second position (i.e. write protect off), the flash memory device according to the invention will still ignore the first CMD1 signal(s) of the MMC, and give priority to using the first protocol (SD).

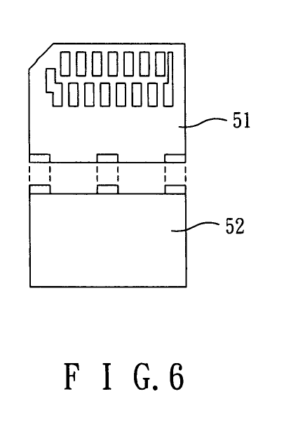

Referring to FIG. 6, the appearance of a reduced MultiMedia card 51 (called RS MMC for short below) is shown. The size of the body of the reduced MultiMedia card 51 is approximately equal to the size of the fore half part of a commonly traditional MMC body. The reduced MultiMedia card 51 has 13 pins and is still compatible with the terminal group of the traditional MMC. When the connection of the reduced MultiMedia card 51 to a traditional MMC card reader is desired, its size specification will be completely the same as a traditional MMC by attaching a second half part 52 of the body. Therefore, the flash memory device with a plurality of protocols according to the invention as well as the control chip and the control method thereof may similarly apply to the reduced MultiMedia card 51.

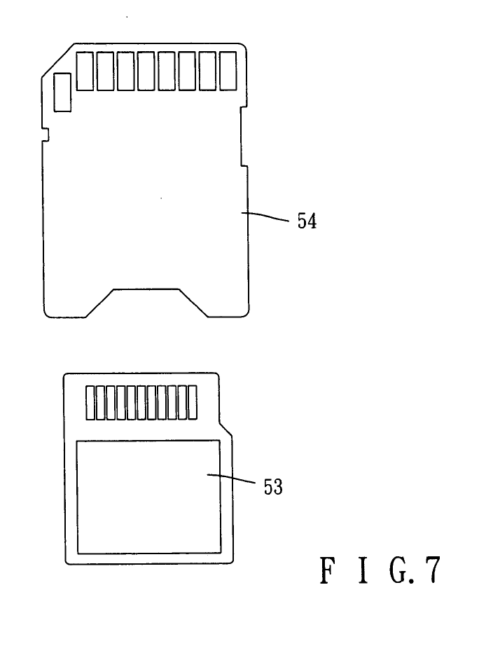

Referring to FIG. 7, the appearance of a mini Secure Digital card 53 (mini SD) is shown. The size of the body of the mini Secure Digital card 53 is smaller than the size of a commonly traditional SD body, and the mini Secure Digital card 53 is unable to be directly connected to a traditionally common SD card reader. However, the protocol of the mini Secure Digital card 53 is backward compatible with the protocol of a traditionally common SD. Therefore, after inserting the mini Secure Digital card 53 into an adapter 54, it will have the same specification of size as a traditional SD, and data can be read out by a traditionally common SD card reader. Therefore, the flash memory device with a plurality of protocols according to the invention as well as the control chip and the control method thereof may similarly apply to the mini Secure Digital card 53.

It should be noted that the above described embodiments are not to be construed as limiting the applicable scope of the invention, but instead the protective scope of the invention should be defined by the technical spirit of the appended claims along with their full scope of equivalents. In other words, equivalents and modifications made based on the appended claims still accords with the intention of the invention and dose not depart from the spirit and scope of the invention. Thus, all should be regarded as further implementions of the invention.

What is claimed is:

1. A flash memory device with a plurality of protocols, comprising:
a body;
a memory device furnished in said body;
a terminal group mounted on one side of said body and connectable with an external device;
a control unit furnished in said body and connected to said memory device and said terminal group, the control unit being able to control data access in said memory device and transfer data via the same terminal group by using at least a first protocol and a second protocol; and
a detection circuit for detecting a specification of protocol supported by said external device, said control unit being switched to use one of the first and second protocols to communicate data according to said external device.

2. The flash memory device with a plurality of protocols according to claim 1, wherein the profile size of said body meets the specification of a Secure Digital card (SD) or a MultiMedia card (MMC), and said first protocol and said second protocol are respectively in sequence Secure Digital card (SD) protocol and MultiMedia card (MMC) protocol.

3. The flash memory device with a plurality of protocols according to claim 2, wherein said control unit further comprises:
a microprocessor connected between said detection circuit and said memory device, said microprocessor enabling said control unit to use said Secure Digital card (SD) protocol or said MultiMedia card (MMC) protocol to transmit data out of said terminal group or receive data from said terminal group;
a memory interface connected between said microprocessor and said memory device, said memory interface enabling said control unit to perform data access in said memory device; and
a buffer storage unit connected to said processor for temporary data storage.

4. The flash memory device with a plurality of protocols according to claim 1, wherein said memory device comprises at least a flash memory.

5. The flash memory device with a plurality of protocols according to claim 1, further comprising a detection procedure stored in said memory device, said detection procedure being able to control said control unit to determine by predefined steps whether said first protocol or said second protocol will be used for transferring data.

6. The flash memory device with a plurality of protocols according to claim 1, further comprising:
a write protect button mounted on one side of said body, said write protect button being switchable between a first position and a second position; and
a switch circuit connected to said write protect button and said control unit, said switch circuit being able to transfer a status of the position of said write protect button in the form of an electric signal to said control unit.

7. The flash memory device with a plurality of protocols according to claim 6, wherein when said write protect button is at said first position, said control unit can use one of said first protocol or said second protocol to make two-way data communication with said external device; when said write protect button is at said second position, said control unit can use said second protocol to make two-way data communication with said external device, but only can use said first protocol to make one-way read-only data transfer.

8. The flash memory device with a plurality of protocols according to claim 6, wherein when said write protect button is at said first position, said control unit will first attempt to use said first protocol to make two-way data communication with said external device; when said write protect button is at said second position, said control unit will first attempt to use said second protocol to make two-way data communication with said external device.

9. The flash memory device with a plurality of protocols according to claim 1, wherein said flash memory device is connectable to a first external device supporting said first protocol and a second external device supporting said second protocol respectively by using the same terminal group for transferring data, and said terminal group is directly electrically connected to said first external device and said second external device without requiring any additional adapter.

10. A flash memory device with a plurality of protocols, comprising:
a body and a write protect button mounted on said body, said write protect button can be switched between a first position and a second position;
a memory device furnished in said body;
a terminal group mounted on one side of said body for electric connection with an external device;
a control unit furnished in said body and connected to said memory device and said terminal group, the control unit being able to control data access in said memory device and communicate data with said external device by using at least a first protocol and a second protocol; and
a switch circuit connected to said write protect button and said control unit, said switch circuit being able to transfer a status of the position of said write protect button in the form of an electric signal to said control unit;
wherein said electric signal produced by the switch position of said write protect button enables said control unit to determine which protocol to use for communicating data with said external device.

11. The flash memory device with a plurality of protocols according to claim 10, wherein when said write protect button is at said first position, said control unit can use one of said first protocol or said second protocol to make two-way data communication with said external device; when said write protect button is at said second position, said control unit can use said second protocol to make two-way data communication with said external device, but only can use said first protocol to make one-way read-only data transfer.

12. The flash memory device with a plurality of protocols according to claim 10, wherein when said write protect button is at said first position, said control unit will first attempt to use said first protocol to make two-way data communication with said external device; when said write protect button is at said second position, said control unit will first attempt to use said second protocol to make two-way data communication with said external device.

13. The flash memory device with a plurality of protocols according to claim 10, wherein said control unit further comprises:
a microprocessor for controlling the use of said first protocol or said second protocol to access data in said memory device; and
a detection circuit for detecting a control signal transferred from said terminal group, and determining according to said control signal whether the first protocol or the second protocol be used by said microprocessor for accessing data.

14. The flash memory device with a plurality of protocols according to claim 10, wherein the profile size of said body meets the specification of a Secure Digital card (SD) or a MultiMedia card (MMC), and said first protocol and said second protocol are respectively in sequence Secure Digital card (SD) protocol and MultiMedia card (MMC) protocol.

15. The flash memory device with a plurality of protocols according to claim 10, wherein said control unit further comprises:
a Secure Digital card/MultiMedia card common interface circuit connected between said terminal group and said detection circuit, for enabling said control unit to use said Secure Digital card (SD) protocol or said MultiMedia card (MMC) protocol to transfer data via said terminal group;
a memory interface connected between said microprocessor and said memory device, for enabling said control unit to perform data access in said memory device; and
a buffer storage unit connected to said processor for temporary data storage.

16. The flash memory device with a plurality of protocols according to claim 10, further comprising a detection procedure stored in said memory device, said detection procedure being able to control said control unit to determine by predefined steps whether said first protocol or said second protocol will be used for transferring data.

17. A method for controlling a flash memory device with a plurality of protocols, the flash memory device being capable of communication using at least a first protocol and a second protocol, said method comprising:
(A) connecting the flash memory device to an external device;
(B) receiving a control signal;
(C) checking if the control signal meets a first protocol signal; if “Yes”, then using the first protocol for communication with the external device;
(D) checking if the control signal meets a second protocol signal; if “Yes”, then proceeding step (E); if “No”, then going back to step (B); and
(E) checking if a buffer value meets a predefined value; if “Yes”, the using the second protocol for communication with the external device; if “No”, then increasing the buffer value with a certain value and going back to step (B).

18. The method of claim 17, wherein the flash memory device comprises a switchable write protect button; said method further comprises the following steps before step (B):
(A1) checking a switching position of the write protect button;
(A2) proceeding step (B) when the write protect button is at a first position;
(A3) checking if a control signal conforming with the first protocol signal is received when the write protect button is at a second position; if “Yes”, then using the first protocol for one-way data read-only communication with the external device; and
(A4) checking if a control signal conforming with the second protocol signal is received when the write protect button is at the first position but without any control signal conforming with the first protocol signal being received; if “Yes”, then using the second protocol for bi-directional communication with the external device.

19. The method of claim 17, wherein the flash memory device meets the specification of a Secure Digital card (SD) or a MultiMedia card (MMC), and said first protocol and said second protocol are respectively in sequence Secure Digital card (SD) protocol and MultiMedia card (MMC) protocol, and said first protocol signal and said second protocol signal are respectively in sequence ACMD41 signal and CMD1 signal.

20. The method of claim 17, wherein the flash memory device comprises:
a body having the write protect button mounted thereon, said write protect button can be switched between the first position and the second position;
a memory device furnished in said body;
a terminal group mounted on one side of said body for electric connection with the external device;
a control unit furnished in said body and connected to said memory device and said terminal group, the control unit being able to control data access in said memory device and communicate data with said external device by using at least the first protocol and the second protocol; and
a switch circuit connected to said write protect button and said control unit, said switch circuit being able to transfer a status of the position of said write protect button in the form of an electric signal to said control unit;
wherein said electric signal produced by the switch position of said write protect button enables said control unit to determine which protocol to use for communicating data with said external device.
